(19) United States
(12) Patent Application Publication
(10) Pub. No.: US 2010/0326081 A1
(43) Pub. Date: Dec. 30, 2010

(54) METHOD FOR MITIGATING A FUEL SYSTEM TRANSIENT

(75) Inventor: David A. Snider, Simpsonville, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/493,740

(22) Filed: Jun. 29, 2009

(51) Int. Cl. F02C 1/00

(52) U.S. Cl. 60/772

(57) ABSTRACT

The present invention takes the form of a method that may reduce the effect of a transient of a fuel system. Essentially, an embodiment of the present invention incorporates a pressure control cell (PCC) with the fuel system. The PCC may be considered an additional volume that removes some of the fuel remaining in the fuel system during a transient event. During a transient event, when a rapid reduction of fuel is required for a fuel circuit, fuel may be allowed to exit a manifold of the fuel system and enter the PCC. This fuel may now be stored within the PCC and may no longer be available to the combustion can. A benefit of the present invention may be a reduced possibility of an undesired increase in rotor speed, and a lean blowout event.

This application is related to commonly-assigned U.S. patent application Ser. No. 12/493,716 [GE Docket 235316], filed Jun. 29, 2009.

### BACKGROUND OF THE INVENTION

The present application relates generally to a fuel system associated with a combustion process; and more particularly to a method for mitigating an effect of a transient on the fuel system.

Fuel systems are associated with a wide-variety of combustion processes of a machine. The fuel system generally serves to transport a fuel, such as, but not limiting of, a natural gas, to the combustion process. The fuel system generally includes a manifold and a valve that collectively control the fuel flow to the combustion process. The fuel system may also control the pressure of the fuel supplied to the valve. The valve may function as the primary control of gas flow to combustion process.

A turbomachine is a non-limiting example of a machine with a combustion process. Some turbomachines, such as, but not limiting of, a gas turbine, an aero-derivative turbine, or the like, have multiple fuel systems that have at least one combustion can. These fuel systems deliver fuel to the combustion can.

Transient requirements for turbomachines, including continued operation after a transient event, are becoming increasingly demanding. During a transient event the fuel flow to the combustion process may be rapidly reduced. A transient include may include, but is not limited to, a load rejection, rapid load shedding, or the like. This may increase the likelihood of an unacceptably high speed of the turbomachine rotor. The high rotor speed may result from the fuel that remains downstream of the valve after the fuel flow is rapidly reduced. This fuel is consumed by the combustion process and may cause the rotor speed increase. Essentially, the control of the fuel flow to the combustion process lags the desired response during a transient event.

During a transient, which affects the fuel system, a known control strategy, generally involves: a) anchoring the flame to the fuel circuit that can sustain the post-transient condition; and b) rapidly reducing the fuel flow to other fuel circuits, if applicable. This strategy involves rapidly reducing the total fuel flow, while attempting to avoid a lean blowout of the combustion can. Due to the compressible volumes of gas fuel remaining in the fuel circuits, after the fuel is rapidly reduced, significant fuel flow to the combustion process may continue. After the transient event, this remaining fuel is combusted, may drive the turbomachine towards an overspeed condition, and may also increase airflow to the combustion can, which may cause a lean blowout.

There are a few disadvantages of using known systems and control philosophies during a transient event. Known systems may have a fuel system that responds relatively slowly during the transient event. Furthermore, some known systems may allow too much air to enter the turbomachine during the transient, increasing the lean blowout risk.

For the aforementioned reasons, there may be a desire for a system for mitigating the effects of a transient on the fuel system. The system should allow for a faster fuel system response during the transient event. The system should also mitigate the risk of an overspeed condition and a lean blowout.

### BRIEF DESCRIPTION OF THE INVENTION

In accordance with an embodiment of the present invention, a method for mitigating a transient experienced by a fuel system, the method comprising: providing a fuel system comprising: a primary fuel circuit configured for delivering a fuel to a combustion process, wherein the primary fuel circuit comprises: a valve configured for controlling a flowrate of the fuel; and a primary manifold configured for apportioning the fuel to components of the combustion process; wherein the primary manifold is located downstream of the valve; and a pressure control cell (PCC) configured for relieving the pressure within the primary manifold during a fuel system transient; detecting the fuel system transient; and utilizing the PCC to reduce a pressure within the primary manifold, after detecting the fuel system transient; wherein the PCC mitigates an effect of the fuel system transient on the fuel system.

In accordance with another embodiment of the present invention, a method for mitigating a transient experienced by a turbomachine, the method comprising: providing a turbomachine comprising a combustion can and a fuel system adapted for delivering a fuel to the combustion can; wherein the fuel system comprises: a first fuel circuit configured for supplying the fuel to the combustion can, wherein the first fuel circuit comprises: a device configured for controlling a flow of the fuel; and a first manifold configured for apportioning the fuel to components of the combustion can; wherein the first manifold is located downstream of the device; and a pressure control cell (PCC) configured for reducing the pressure within the first manifold during a fuel system transient; detecting the fuel system transient; and utilizing the PCC to relieve pressure within the primary manifold, after detecting the fuel system transient; wherein the PCC performs a step of removing a potion of the fuel within the primary manifold during the fuel system transient, and mitigating an effect of the fuel system transient on the fuel system.

### BRIEF DESCRIPTION OF THE DRAWING

FIG. 1 is a schematic illustrating the environment in which an embodiment of the present invention operates.

FIG. 2 is a schematic illustrating an example of the fuel supply system associated with the turbomachine illustrated in FIG. 1.

FIGS. 3A to 3C, collectively FIG. 3, are graphs illustrating an example of an operation of the fuel supply system illustrated in FIG. 2, during a transient event.

FIG. 4 is a schematic illustrating an embodiment of a pressure control cell system integrated with a fuel supply system, in accordance with an embodiment of the present invention.

FIGS. 5A to 5C, collectively FIG. 5, are graphs illustrating an example of an operation of the pressure control cell system of FIG. 4, during a transient event, in accordance with an embodiment of the present invention.

FIG. 6 is a flowchart illustrating a method of operating the pressure control cell system, in accordance with an embodiment of the present invention.

FIG. 7 is a block diagram of an exemplary system for operating the pressure control cell system of FIG. 4, in accordance with an embodiment of the present invention.

### DETAILED DESCRIPTION OF THE INVENTION

Certain terminology is used herein for convenience only and is not to be taken as a limitation on the invention. For example, words such as “upper,” “lower”, “left”, “front”, “right”, “horizontal”, “vertical”, “upstream”, “downstream”, “fore”, “aft”, “top”, “bottom”, “upper”, and “bottom” merely describe the configuration shown in the FIGS. Indeed, the components may be oriented in any direction and the terminology, therefore, should be understood as encompassing such variations unless specified otherwise.

As used herein, an element or step recited in the singular and preceded with “a” or “an” should be understood as not excluding plural elements or steps, unless such exclusion is explicitly recited. Furthermore, references to “an embodiment” of the present invention are not intended to exclude additional embodiments incorporating the recited features.

The present invention has the technical effect of reducing an effect of a transient on a fuel system. The following discussion focuses on an embodiment of the present invention integrated with a fuel system of a turbomachine, such as, but not limiting of, a gas turbine having a combustion can. Other embodiments of the present invention may be integrated with other fuel systems that require mitigation of the effects of a transient event.

Essentially, an embodiment of the present invention incorporates a pressure control cell (PCC) with the fuel system. The PCC may be considered an additional volume that is part of a system that removes some of the fuel remaining in the fuel system during a transient event. During a transient, event when a rapid reduction of fuel is required for a fuel circuit, fuel may be allowed to exit a manifold of the fuel system and enter the PCC. This fuel may now be stored within the PCC and may no longer be available to the combustion can. A benefit of the present invention may be a reduced possibility: of an undesired increase in rotor speed, and a lean blowout event from occurring.

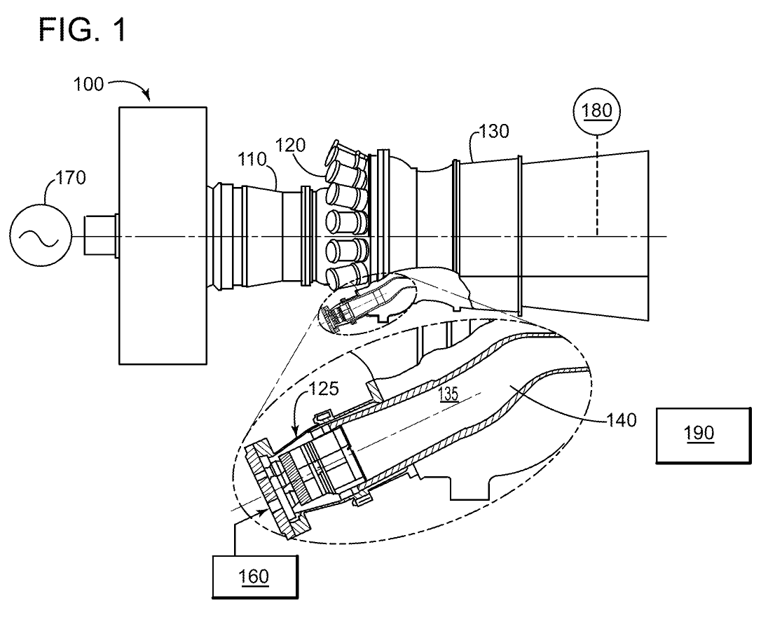

Referring now to the FIGS., where the various numbers represent like parts and/or elements throughout the several views, FIG. 1 is a schematic illustrating the environment in which an embodiment of the present invention operates. In FIG. 1, a turbomachine 100 includes: a compressor section 110; a plurality of combustion cans 120 of a combustion system, with each can 120 comprising fuel nozzles 125; a turbine section 130; and a flow path 135 leading to a transition section 140. A fuel supply system 160 may provide a fuel, such as, but not limiting of, a natural gas, to the combustion system.

Generally, the compressor section 110 includes a plurality of inlet guide vanes (IGVs) and a plurality of rotating blades and stationary vanes structured to compress a fluid. The plurality of combustion cans 120 may be coupled to the fuel supply system 160. Within each combustion can 120 the compressed air and fuel are mixed, ignited, and consumed within the flow path 135, thereby creating a working fluid.

The flow path 135 of the working fluid generally proceeds from the aft-end of the fuel nozzles 125 downstream through the transition section 140 into the turbine section 130. The turbine section 130 includes a plurality of rotating and stationary components, neither of which are shown, that convert the working fluid to a mechanical torque, which may be used to drive a load 170, such as, but not limiting of, a generator, mechanical drive, or the like. The output of the load 170 may be used by a turbine control system 190, or the like, as a parameter to control the operation of the turbomachine 100. Exhaust temperature data 180 may be also used by a turbine control system 190, or the like, as a parameter to control the operation of the turbomachine 1100.

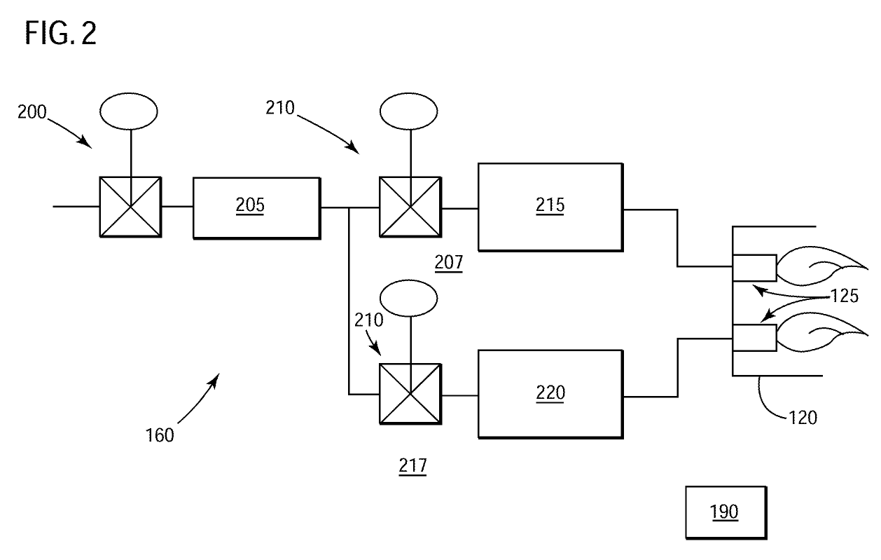

FIG. 2 is a schematic illustrating an example of the fuel supply system 160 associated with the turbomachine 100 illustrated in FIG. 1. An example of the fuel supply system 160 comprises a stop valve 200 having an upstream end that receives the fuel. The stop valve 200 generally regulates the pressure of the fuel supply system 160. A downstream end of the stop valve 200 may be directly or indirectly connected to an upstream end of an intermediate volume 205, which may be referred as a “P2 volume”. The intermediate volume 205 and the stop valve 200 may operatively function as a pressure regulator of the fuel supply system 160.

A fuel circuit may be considered the components and structures within the fuel supply system 160 that deliver the fuel to the fuel nozzles 125. As illustrated in FIG. 2, some turbomachines 100 may comprise multiple fuel circuits. The present invention is not intended to be limited to a turbomachine 100 comprising multiple fuel circuits. An embodiment of the present invention may be used with a turbomachine 100 comprising a single fuel circuit. Furthermore, the present invention is not intended to be limited to for use on a turbomachine 100. An embodiment of the present invention may apply at any machine comprising a single or multiple fuel circuits.

FIG. 2 illustrates a non-limiting example of a primary circuit 207 of the fuel supply system 160. Here, the primary circuit 207 may comprise a control valve 210 and a primary manifold 215. The control valve 210 may receive the fuel from the intermediate volume 205. The control valve 210 may also control the flow of the fuel entering the primary manifold 215, which generally serves to distribute the received fuel to some of the fuel nozzles 125.

The additional circuit 217 may have a similar general configuration as the primary circuit 207. Here, the additional circuit 217 may comprise a control valve 210 and an additional manifold 220. As described, The control valve 210 may control the flow of the fuel entering the additional manifold 220, which generally serves to distribute the received fuel to some of the fuel nozzles 125 of the combustion can 120.

Typically, a turbomachine 100, comprising multiple fuel circuits, may utilize a fuel staging process, which essentially ports fuel to a designate circuit at particular operational ranges. For example, but not limiting of, the primary circuit 207 may receive fuel for the majority of a loading range, while additional circuit(s) 217 may only receive fuel during higher loading ranges. Furthermore, there may be operational ranges when both fuel circuits 207, 217 receive fuel, such as, but not limiting of, baseload operation.

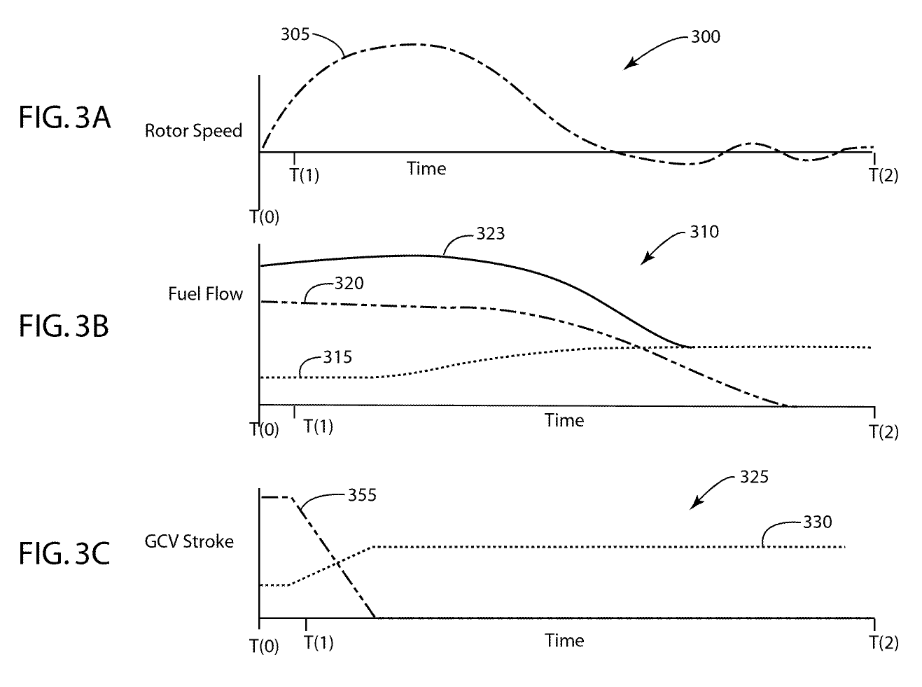

FIGS. 3A to 3C, collectively FIG. 3, are graphs illustrating an example of an operation of the fuel supply system 160 illustrated in FIG. 2, during a transient event. A transient event may be detected by the turbine control system 190. The control valves 190 of the primary circuit 207 and the additional circuit 217 begin to close to reduce fuel flow. As this occurs, pressure within the primary and the additional manifold 215, 220 is reduced from the fuel flow exiting the manifolds 215, 220 through the nozzle effective area associated with the fuel nozzles 125. The fuel flow is driven by the pressure difference between the manifold and the combustion can 120.

The control system 190 also controls the fuel flow with an aim of reducing the possibility of an undesired increase in the speed of the rotor. The undesired increase in rotor speed tends to drive more airflow, leading to a reduction in the fuel-to-air (F/A) ratio, which may make a lean-blowout of the combustion system more likely. Therefore, by reducing the amount of the rotor speed increase, the likelihood of a lean-blowout event may be significantly reduced.

Collectively FIG. 3 illustrates operational parameters of the turbomachine 100 versus time during a transient event. These operational parameters may be generally considered operational data 180. The horizontal time axis of FIG. 3 includes three specific periods, which are, in sequential order: T(0), T(1) and T(2). T(0) may be considered the time when the transient occurs. T(1) may be considered the time when the turbine control system 190 responds to the transient event. T(2) may be considered the time when the turbomachine 100 arrives at a nearly steady state operation.

FIG. 3A is a chart 300 illustrating the rotor speed of the turbomachine 100 versus time. Here, the rotor speed is represented by a speed_1 data series 305. FIG. 3B is a chart 310 illustrating the fuel flow of the turbomachine 100 versus time. Here, the fuel flow of the primary manifold 215 is represented by a PF_1 data series 315; the fuel flow of the additional manifold 220 is represented by an AF_1 data series 320; and the total fuel flow is represented by a TF_1 data series 323. FIG. 3C is a chart 325 illustrating the control valve stroke of the turbomachine 100 versus time. Here, the position of the control valves 210, of the primary circuit 207 and the additional circuit 217 is respectively represented by a PS_1 data series 330; and the fuel flow of the additional manifold 220 is represented by an AS_1 data series 335. As illustrated throughout FIG. 3, the rotor speed greatly increases well after the turbine control system 190 begins to respond to the transient event. At time T(1) the acceleration of the rotor continues, although the fuel flow and control valve stroke decrease. As described, this continued acceleration of the rotor might be due to the fuel remaining in the manifold(s) of the fuel supply system 160, which is then burned in the combustion can 120.

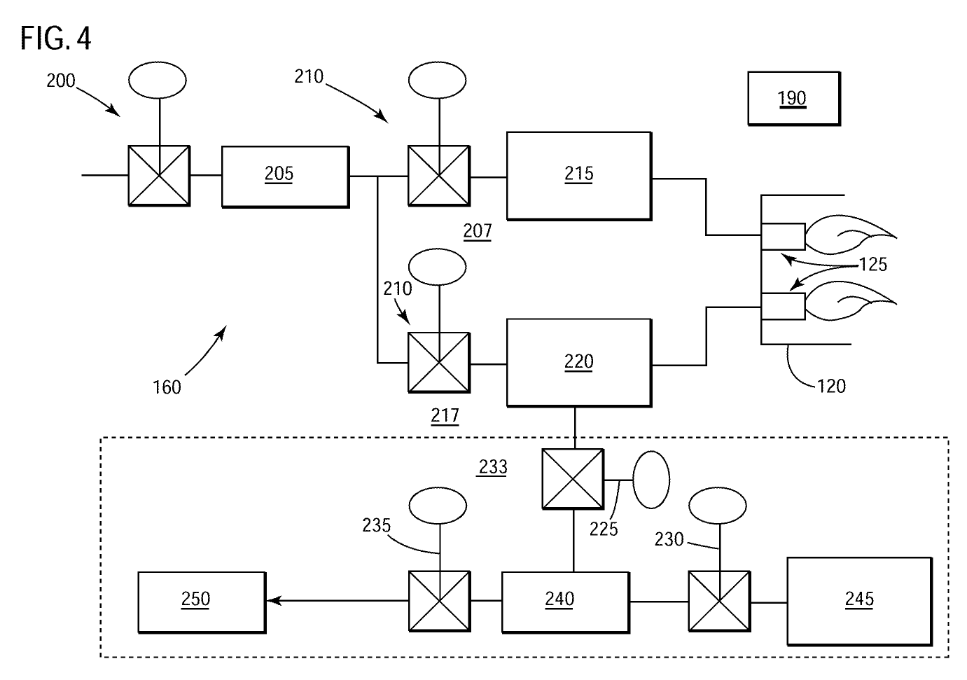

FIG. 4 is a schematic illustrating an embodiment of a pressure control cell system 223 integrated with a fuel supply system 160, in accordance with an embodiment of the present invention. An embodiment of the pressure control cell system 223 may be integrated with a variety of fuel supply system 160, including those not illustrated in FIGS. 2 and 4. The discussion below focuses on a non-limiting embodiment of the pressure control cell system 223 integrated with the fuel supply system 160 discussed in FIGS. 2 and 4.

Essentially, an embodiment of the present invention integrates an independent volume, a primary control cell (PCC) 240, with the fuel supply system 160. Fuel flow into and out of the PCC 240 may be controlled by at least one valve. The PCC 240 may be initially filled with a fluid such as, but not limiting of, an inert gas, air, or combinations thereof; at a pressure close to ambient. During a transient event, an embodiment of the present invention may allow the fuel to flow from a fuel manifold to the PCC 240.

An embodiment of the present invention may provide a valve, which controls the flow into the PCC 240, having a much larger effective area than that of the fuel nozzles 125. This feature may allow for the respective manifold pressure to be reduced relatively faster than other known systems. This feature may also allow the pressure in the PCC 240 to increase, while pressure of the fuel manifold decreases. The fuel volume that is now within the PCC 240 may be considered the energy no longer available to accelerate the rotor. An additional benefit of the present invention is that the reduced rotor acceleration may also reduce the maximum airflow, reducing the likelihood of a lean blowout event. After a steady state condition of the turbomachine 100 has been reached, the fuel from the additional volume may be slowly discharged via a fuel discharge 250.

Referring back to FIG. 4, an embodiment of the pressure control cell system 223 may comprise: a first PCC valve 225, a second PCC valve 230, a third PCC valve 235, a primary control cell (PCC) 240, a purge source 245, and a fuel discharge 250. The first PCC valve 225 generally serves to isolate the pressure control cell system 223 from the fuel supply system 160. Specifically, in an embodiment of the present invention, the first PCC valve 225 may control the flow of the fuel exiting the additional manifold 220 and entering the PCC 240. The second PCC valve 230 generally serves to isolate the PCC 240 from the purge source 245. Specifically, in an embodiment of the present invention, the second PCC valve 230 may control the flow of the purge fluid exiting the purge source 245 and entering the PCC 240. The third PCC valve 235 generally serves to isolate the PCC 240 from the fuel discharge 250. Specifically, in an embodiment of the present invention, the third PCC valve 235 may control the flow of the fuel exiting the PCC 240 and entering the fuel discharge 250.

The PCC 240 essentially serves as a temporary volume for receiving the excess fuel within a manifold, such as, but not limiting of the primary manifold 215, or the additional manifold 220, of the fuel supply system 160. This excess fuel may be a result of the transient event, as described. The size of the PCC 240 may be customized to support a particular combustion system. For example, but not limiting of, a particular combustion system may require a PCC 240 having a volume comprising a range of from about 5 cubic feet to about 25 cubic feet.

The pressure control cell system 223 may allow for the first PCC valve 225 to be opened to an effective area many times larger than the effective area of the fuel nozzles 125. This feature may allow for most of the excess fuel, which may lead to an overspeed event, to be transferred in the volume of the PCC 240.

The purge source 245 may provide a purge fluid, such as, but not limiting of, an inert gas, air, or combinations thereof, to the PCC 240. This may provide the pressure control cell system 223 with multiple benefits. When the second PCC valve 230 is opened, the purge source 245 may allow for the purge fluid to drive the fuel out of the PCC 240. Also, the purge fluid may be used to clean or sweep the PCC 240 after the fuel is purged. This may aid in preparing the pressure control cell system 223 for a future use.

The fuel discharge 250 generally allows for the majority of the fluid within the PCC 240 to exit the pressure control cell system 223. When the third PCC valve 235 is opened the fuel and/or purge fluid within the PCC 240 to exit. The fuel discharge 250 may be in the form of a ventilation system of the like. In an embodiment of the present invention, the fuel discharge 250 may comprise a component of a system of the turbomachine 100. Here, the fuel discharge 250 may include, but is not limiting to, an exhaust system and/or the compressor inlet system of the turbomachine 100.

In use, the pressure control cell system 223 may initially flush the PCC 240 with the purge fluid. Then, the PCC valves 225, 230, and 235 may be in a closed position and the turbomachine 100 may be operating in a normal mode.

As discussed, the response by the turbine control system 190 to the transient event may be slightly delayed until operating data 180 on the transient event is received and/or until the turbine control system 190 may detect rotor acceleration and an increase in the rotor speed. After detection of the transient event, the turbine control system 190 may adjust the position of each control valve 210 of the primary and additional circuits 207, 217. For example, but not limiting of, the control valve 210 of the primary circuit 207 may be opened to anchor the flame with the goal of reducing the chance of a lean blowout event. Nearly simultaneously, the control valve(s) 210 of the additional circuit(s) 217 may be closed with the goal of reducing the fuel flow and controlling the rotor speed.

Next, after the primary circuit 207 anchors the flame, the pressure control cell system 223 may open the first PCC valve 225. As discussed, an embodiment of the first PCC valve 225 may be a valve with an effective area much larger than the effective area fuel nozzles 125. This may also for the excess fuel remaining in the additional manifold 220 to flow into the PCC 240. This may prevent the combustion of the excess fuel in the additional manifold 220, as described.

Next, when the turbomachine 100 achieves a relatively steady state condition, the pressure with the PCC 240 and the additional manifold 220 may be nearly equal to the compressor discharge pressure. Then, the first PCC valve 225 may be closed and the third PCC valve 235 may be opened to allow the fuel within the PCC 240 to flow towards the fuel discharge 250. Then, the second PCC valve 230 may be opened and the first PCC valve 225 may be closed. This may allow for the purge fluid of the purge source 245 to flush the fuel within the PCC 240 towards the fuel discharge 250.

Next, when the pressure within the PCC 240 has decreased to a desired amount, the second PCC valve 230 and the third PCC valve 235 may then be closed. This may configured/reset the pressure control cell system 223 to a normal state.

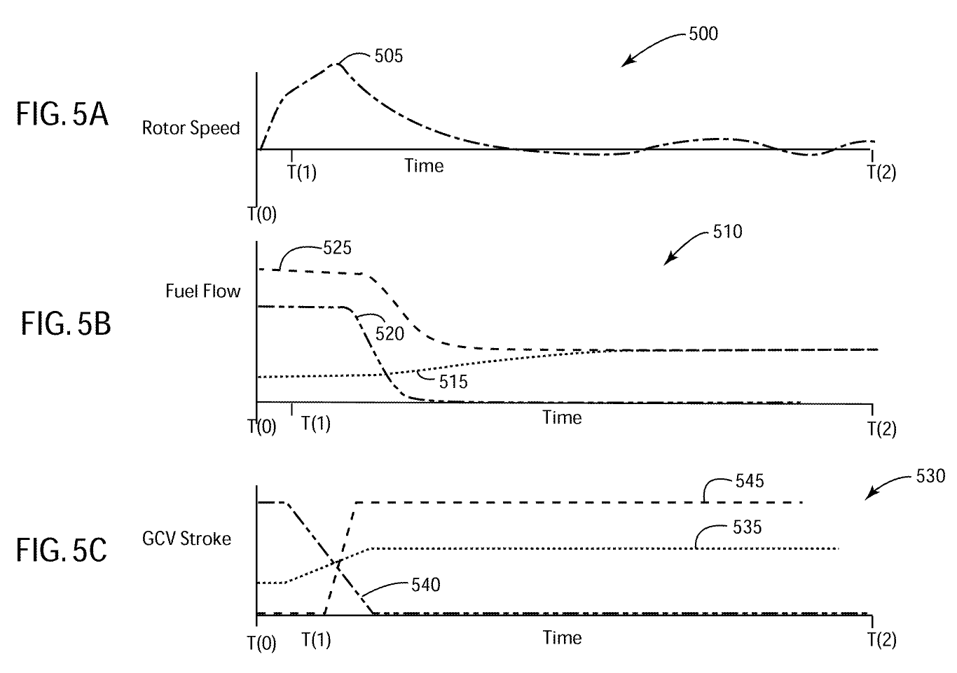

FIGS. 5A to 5C, collectively FIG. 5, are graphs illustrating an example of an operation of the pressure control cell system 223 of FIG. 4, during a transient event, in accordance with an embodiment of the present invention. Collectively FIG. 5 illustrates operational data 180 of the turbomachine 100 versus time during a transient event occurring on a turbomachine 100 equipped with an embodiment of the pressure control cell system 223 of the present invention. The horizontal time axis of FIG. 5 includes three specific periods, which are, in sequential order: T(0), T(1) and T(2). T(0) may be considered the time when the transient event occurs. T(1) may be considered the time when the turbine control system 190 responds to the transient event. T(2) may be considered the time when the turbomachine 100 arrives at a nearly steady state operation.

FIG. 5A is a chart 500 illustrating the rotor speed of the turbomachine 100 versus time. Here, the rotor speed is represented by a speed_2 data series 505. FIG. 5B is a chart 510 illustrating the fuel flow of the turbomachine 100 versus time. Here, the fuel flow of the primary manifold 215 is represented by a PF_2 data series 515; the fuel flow of the additional manifold 220 is represented by an AF_2 data series 520; and the total fuel flow is represented by a TF_2 data series 525. FIG. 5C is a chart 530 illustrating the control valve stroke of the turbomachine 100 versus time. Here, the position of the control valves 210, of the primary circuit 207 and the additional circuit 217 is respectively represented by a PS 2 data series 535; and the fuel flow of the additional manifold 220 is represented by an AS_2 data series 540. FIG. 5C also illustrates the position of the first PCC valve 225 represented as the PCC_S data series 545.

The benefits of an embodiment of the present invention are simply illustrated by like comparisons of FIG. 3 and FIG. 5. As illustrated throughout FIG. 5, the rotor speed increase is considerably less at T(1) when comparing FIGS. 3A and 5A. This may represent the decrease in the fuel burned by the additional circuit 217. Also, as shown by comparing FIGS. 3B and 5B, the total fuel flow nearly equals that of the primary circuit 207 substantially faster under an embodiment of the pressure control cell system 223.

As will be appreciated, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system”. Furthermore, the present invention may take the form of a computer program product on a computer-usable storage medium having computer-usable program code embodied in the medium. As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

Computer program code for carrying out operations of the present invention may be written in an object oriented programming language such as Java7, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram blocks.

An embodiment of present invention may be operated by the turbine control system 190, or the like. The turbine control system 190, of an embodiment of the present invention, may be configured to automatically and/or continuously monitor the turbomachine 100 to determine whether the pressure control cell system 223 should operate.

Alternatively, the turbine control system 190 may be configured to require a user action to the initiate operation of the pressure control cell system 223. An embodiment of the turbine control system 190 of the present invention may function as a stand-alone system. Alternatively, the turbine control system 190 may be integrated as a module, or the like, within a broader system, such as, but not limiting of a plant control system, a distributed control system, or the like.

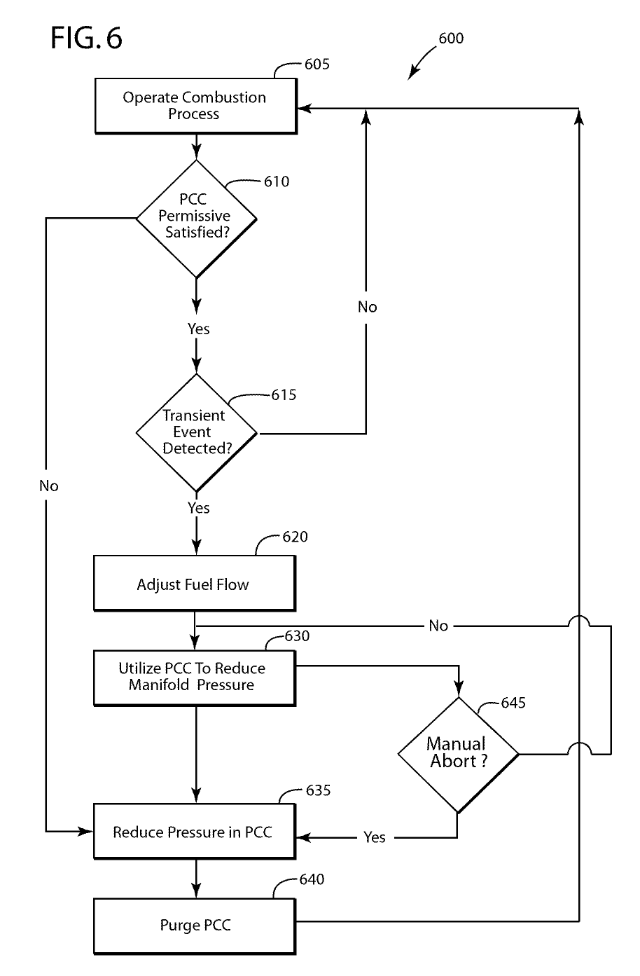

FIG. 6 is a flowchart diagram illustrating a method 600 of operating the pressure control cell system 223, in accordance with an embodiment of the present invention. In an embodiment of the present invention the turbine control system 190 that implements the method 600 may be integrated with a graphical user interface (GUI), or the like. The GUI may allow an operator to navigate through the method 600 described below. The GUI may also provide at least one notification of the status of the pressure control cell system 223.

The method 600 may be adapted to control the operation of a variety of configurations of the pressure control cell system 223. This may include, but is not limited to, previously described embodiments of the pressure control cell system 223.

In step 605, of the method 600, a combustion process may be in operation. As described, a non-limiting example of a combustion process involves a turbomachine 100 having at least one combustion can 120. The following discussion describes an application of the method 600 on a turbomachine 100 integrated with a pressure control cell system 223. The method 600 may be modified to operate other machines that have a combustion process.

In step 610, the method 600 may determine whether a permissive is satisfied. An embodiment of the present invention may require that a PCC permissive to operate the pressure control cell system 223 is satisfied before operation. The PCC permissive may generally be considered a permissive that confirms the pressure control cell system 223 may be ready to operate if the turbine control system 190 detects a transient event that may affect the fuel supply system 160. The PCC permissive may include, but is not limited to: a) confirmation of a ready position of the PCC valves 225,230,235; b) indication that the purge source 245 has adequate pressure and/or supply of the purge fluid; c) indication that the PCC 240 has been purged; or the like. In an embodiment of the present invention, the user may define the PCC permissive. If the initialization permissive is satisfied, then the method 600 may proceed to step 615; otherwise the method 600 may jump to step 635, where the method 600 may begin to reset the pressure control cell system 223.

In an embodiment of the present invention, the method 600 may provide a notification to the user that the pressure control cell system 223 is initialized and ready for essentially operation. In an embodiment of the present invention, the GUI may provide the notification as a pop-up window, alarm, or other similar methods.

In step 615, the method 600 may determine whether a transient event has been detected. As discussed, a transient include may include, but is not to, a load rejection, rapid load shedding, or the like. The turbine control system 190 may receive the operating data 180, which may comprise the operational parameters used in FIGS. 3 and 5. Here, the method 600 may determine whether a transient event has occurred, as previously described. If a transient event has occurred, then the method 600 may proceed to step 620; otherwise the method 600 may revert to step 605.

In step 620, the method 600 may adjust a fuel flow to the fuel supply system 160. As discussed, the turbine control system 190 may adjust the position of each control valve 210 of the primary and additional circuits 207, 217 in an effort to reduce the likelihood of an overspeed event. For example, but not limiting of, the control valve 210 of the primary circuit 207 may be opened to anchor the flame with the goal of reducing the chance of a lean blowout event. Nearly simultaneously, the control valve(s) 210 of the additional circuit(s) 217 may be closed with the goal of reducing the fuel flow and to controlling the rotor speed.

In step 630, the method 600 may modulate the first PCC valve 225 to an open position. An embodiment of the first PCC valve 225 may be a valve with an effective area much larger than the effective area fuel nozzles 125. This may allow for the excess fuel remaining in the additional manifold 220 to flow into the PCC 240. This may prevent the combustion of the excess fuel in the additional manifold 220.

In step 635, the method 600 may reduce the pressure and/or the quantity of fuel within the PCC 240. The turbine control system 190 may determine when the turbomachine 100 achieves a relatively steady state condition. Here, the method 600 may modulate, the first PCC valve 225 to a closed position and then modulate the third PCC valve 235 to an open position. This may allow the fuel within the PCC 240 to flow towards the fuel discharge 250. As discussed, step 635 may also be used to begin the process of resetting the pressure control cell system 223, as described.

In step 640, the method 600 may purge the PCC 240. Here, the method 600 may modulate the second PCC valve 230 to an open position and the first PCC valve 225 may be modulated to a closed position. This may allow for the purge fluid of the purge source 245 to move the fuel within the PCC 240 towards the fuel discharge 250. An embodiment of the method 600 may then determine when the pressure within the PCC 240 has decreased to a desired amount. Then the second PCC valve 230 and the third PCC valve 235 may modulate to a closed position. This may configured and/or return the pressure control cell system 223 to a normal or “ready” state. As illustrated in FIG. 6, in an embodiment of the present invention, the method 600 may revert to step 605 after step 640 is substantially complete.

In step 645, the method 600 may allow for aborting the operation of the pressure control cell system 223. As illustrated in FIG. 6, an embodiment of the method 600 may allow for aborting the operation of the pressure control cell system 223 during and/or after step 630. An embodiment of the present invention, may allow for a user to manually abort the operation of the pressure control cell system 223. Alternatively, the method 600 may be integrated with a system, such as, but not limiting of, a plant control system, which allows for the automatic aborting of the operation of the pressure control cell system 223. If the operation of pressure control cell system 223 is aborted, then the method 600 may proceed to step 635; otherwise the method 600 may revert to step 630.

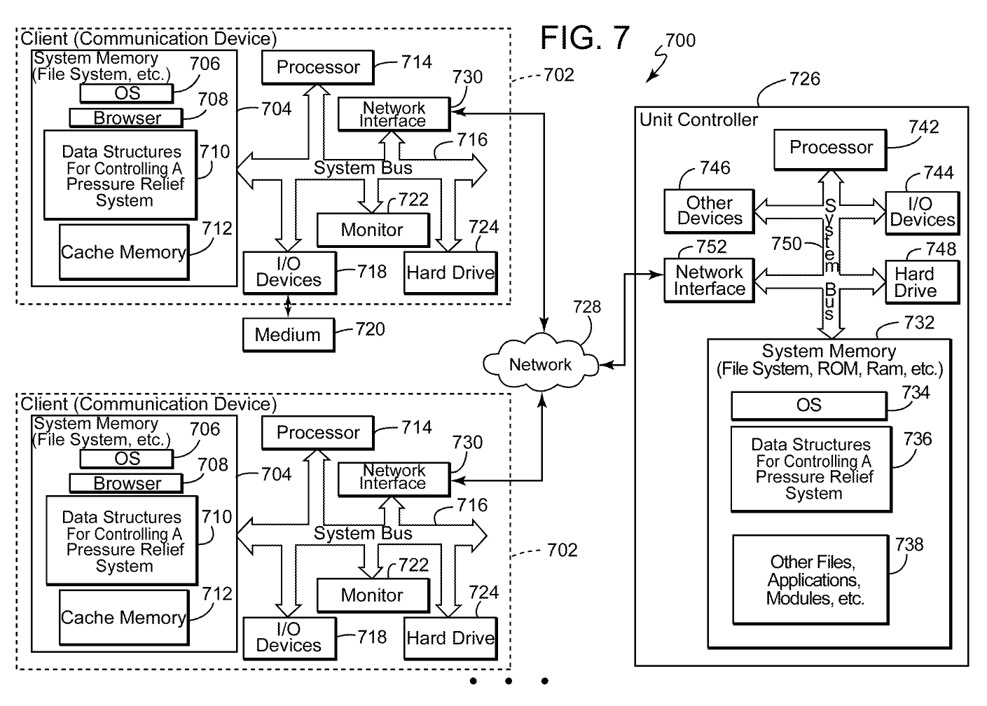

FIG. 7 is a block diagram of an exemplary system 700 for operating the pressure control cell system 223, in accordance with an embodiment of the present invention. The elements of the method 700 may be embodied in and performed by the system 700. The system 700 may include one or more user or client communication devices 702 or similar systems or devices (two are illustrated in FIG. 7). Each communication device 702 may be for example, but not limited to, a computer system, a personal digital assistant, a cellular phone, or any device capable of sending and receiving an electronic message.

The communication device 702 may include a system memory 704 or local file system. The system memory 704 may include for example, but is not limited to, a read only memory (ROM) and a random access memory (RAM). The ROM may include a basic input/output system (BIOS). The BIOS may contain basic routines that help to transfer information between elements or components of the communication device 702. The system memory 704 may contain an operating system 706 to control overall operation of the communication device 702. The system memory 704 may also include a browser 708 or web browser. The system memory 704 may also include data structures 610 or computer-executable code for operating the pressure control cell system 223 that may be similar or include elements of the method 600 in FIG. 6.

The system memory 704 may further include a template cache memory 712, which may be used in conjunction with the method 700 in FIG. 6 for operating the pressure control cell system 223.

The communication device 702 may also include a processor or processing unit 714 to control operations of the other components of the communication device 702. The operating system 706, browser 708, and data structures 710 may be operable on the processing unit 714. The processing unit 714 may be coupled to the memory system 704 and other components of the communication device 702 by a system bus 716.

The communication device 702 may also include multiple input devices (I/O), output devices or combination input/output devices 718. Each input/output device 718 may be coupled to the system bus 716 by an input/output interface (not shown in FIG. 7). The input and output devices or combination I/O devices 718 permit a user to operate and interface with the communication device 702 and to control operation of the browser 708 and data structures 710 to access, operate and control the software to utilize a pressure control cell system 223. The I/O devices 718 may include a keyboard and computer pointing device or the like to perform the operations discussed herein.

The I/O devices 718 may also include for example, but are not limited to, disk drives, optical, mechanical, magnetic, or infrared input/output devices, modems or the like. The I/O devices 718 may be used to access a storage medium 720. The medium 720 may contain, store, communicate, or transport computer-readable or computer-executable instructions or other information for use by or in connection with a system, such as the communication devices 702.

The communication device 702 may also include or be connected to other devices, such as a display or monitor 722. The monitor 722 may permit the user to interface with the communication device 702.

The communication device 702 may also include a hard drive 724. The hard drive 724 may be coupled to the system bus 716 by a hard drive interface (not shown in FIG. 7). The hard drive 724 may also form part of the local file system or system memory 704. Programs, software, and data may be transferred and exchanged between the system memory 704 and the hard drive 724 for operation of the communication device 702.

The communication device 702 may communicate with at least one unit controller 726 and may access other servers or other communication devices similar to communication device 702 via a network 728. The system bus 716 may be coupled to the network 728 by a network interface 730. The network interface 730 may be a modem, Ethernet card, router, gateway, or the like for coupling to the network 728. The coupling may be a wired or wireless connection. The network 728 may be the Internet, private network, an intranet, or the like.

The at least one unit controller 726 may also include a system memory 732 that may include a file system, ROM, RAM, and the like. The system memory 732 may include an operating system 734 similar to operating system 706 in communication devices 702. The system memory 732 may also include data structures 736 for controlling the pressure control cell system 223. The data structures 736 may include operations similar to those described with respect to the method 700 for the pressure control cell system 223. The server system memory 732 may also include other files 738, applications, modules, and the like.

The at least one unit controller 726 may also include a processor 742 or a processing unit to control operation of other devices in the at least one unit controller 726. The at least one unit controller 726 may also include I/O device 744. The I/O devices 744 may be similar to I/O devices 718 of communication devices 702. The at least one unit controller 726 may further include other devices 746, such as a monitor or the like to provide an interface along with the I/O devices 744 to the at least one unit controller 726. The at least one unit controller 726 may also include a hard disk drive 748. A system bus 750 may connect the different components of the at least one unit controller 726. A network interface 752 may couple the at least one unit controller 726 to the network 728 via the system bus 750.

The flowcharts and step diagrams in the figures illustrate the architecture, functionality, and operation of possible implementations of systems, methods, and computer program products according to various embodiments of the present invention. In this regard, each step in the flowchart or step diagrams may represent a module, segment, or portion of code, which comprises one or more executable instructions for implementing the specified logical function(s). It should also be noted that, in some alternative implementations, the functions noted in the step may occur out of the order noted in the figures. For example, two steps shown in succession may, in fact, be executed substantially concurrently, or the steps may sometimes be executed in the reverse order, depending upon the functionality involved. It will also be noted that each step of the step diagrams and/or flowchart illustration, and combinations of steps in the step diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

Although the present invention has been shown and described in considerable detail with respect to only a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings.

Accordingly, we intend to cover all such modifications, omissions, additions, and equivalents as may be included within the spirit and scope of the invention as defined by the following claims. For example, but not limiting of, FIGS. 2 and 4 illustrate just one additional circuit 217. Other embodiments of the present invention may be integrated with a fuel supply system 160 comprising more additional circuits 217. As another example, but not limiting of, FIGS. 2 and 4 illustrate the pressure control cell system 223 integrated with the additional circuit 217. Other embodiments of the present invention may integrate the pressure control cell system 223 with the primary circuit 207. Furthermore, other embodiments of the present invention may integrate one PCC 240 with multiple manifolds of the fuel supply system 160. Alternatively, other embodiments of the present invention have a fuel supply system 160 configured with one PCC 240 per manifold.

What is claimed is:

1. A method of mitigating a transient experienced by a fuel system, the method comprising:
providing a fuel system comprising:
a primary fuel circuit configured for delivering a fuel to a combustion process, wherein the primary fuel circuit comprises:
a valve configured for controlling a flowrate of the fuel; and
a primary manifold configured for apportioning the fuel to components of the combustion process; wherein the primary manifold is located downstream of the valve; and
a pressure control cell (PCC) configured for relieving the pressure within the primary manifold during a fuel system transient;
detecting the fuel system transient; and
utilizing the PCC to reduce a pressure within the primary manifold, after detecting the fuel system transient;
wherein the PCC mitigates an effect of the fuel system transient on the fuel system.

2. The method of claim 1 further comprising relieving a pressure within the PCC.

3. The method of claim 2 further comprising: utilizing a fuel discharge to reduce the pressure with the PCC; wherein the fuel discharge is configured for discharging the fuel within the PCC.

4. The method of claim 1 further comprising purging the PCC.

5. The method of claim 4 further comprising: utilizing a purge source to purge the PCC.

6. The method of claim 5, wherein the purge source comprises at least one of: an inert gas; air; or combinations thereof.

7. The method of claim 1 further comprising: adjusting a fuel flow of the fuel system after detecting the fuel system transient.

8. The method of claim 1, wherein the primary fuel system further comprises: a PCC circuit that comprises: the PCC; a first PCC valve located between the primary manifold and the PCC; a second PCC valve located between a purge source and the PCC; and a third PCC valve located between a fuel discharge and the PCC.

9. The method of claim 8 further comprising: modulating the first PCC valve to a position allowing for the fuel to travel from the primary manifold to the PCC; after the fuel system transient has been detected.

10. The method of claim 9 further comprising: modulating the second PCC valve to a position allowing for the fuel to flow from the PCC to the fuel discharge.

11. The method of claim 10 further comprising: modulating the third PCC valve to a position allowing for the purge source to purge the PCC.

12. A method of mitigating a transient experienced by a turbomachine, the method comprising:
providing a turbomachine comprising a combustion can and a fuel system adapted for delivering a fuel to the combustion can; wherein the fuel system comprises: a first fuel circuit configured for supplying the fuel to the combustion can, wherein the first fuel circuit comprises:
a device configured for controlling a flow of the fuel; and
a first manifold configured for apportioning the fuel to components of the combustion can; wherein the first manifold is located downstream of the device; and
a pressure control cell (PCC) configured for reducing the pressure within the first manifold during a fuel system transient;
detecting the fuel system transient; and
utilizing the PCC to relieve pressure within the primary manifold, after detecting the fuel system transient,
wherein the PCC performs a step of removing a potion of the fuel within the primary manifold during the fuel system transient, and mitigating an effect of the fuel system transient on the fuel system.

13. The method of claim 12, wherein the fuel system further comprises a second additional circuit comprising: a second manifold for receiving the fuel intended for the second circuit, and a second valve for controlling a flow of the fuel and is located upstream of the second manifold.

14. The method of claim 12 further comprising removing a portion of the fuel within the PCC.

15. The method of claim 13 further comprising: utilizing a fuel discharge to reduce the pressure within the PCC.

16. The method of claim 12 further comprising: utilizing a purge source to purge the PCC.

17. The method of claim 15, wherein the fuel discharge is integrated with a system of the turbomachine.

18. The method of claim 12, wherein the primary fuel system further comprises: a PCC circuit comprising: the PCC; a first PCC valve located between the primary manifold and the PCC; a second PCC valve located between a purge source and the PCC; and a third PCC valve located between a fuel discharge and the PCC.

19. The method of claim 18 further comprising:
determining whether the fuel system transient has been detected; and
modulating the first PCC valve to a position allowing for the fuel to travel from the primary manifold to the PCC.

20. The method of claim 19 further comprising:
modulating the second PCC valve to a position allowing for the fuel to travel from the PCC to the fuel discharge; and
modulating the third PCC valve to a position allowing for the purge source to purge the PCC.
